(19) United States
(12) Patent Application Publication
(10) Pub. No.: US 2012/0310607 A1
(43) Pub. Date: Dec. 6, 2012

(54) ENGINEERING STRUCTURE MULTI-OBJECTIVE PERFORMANCE-BASED SEISMIC DESIGN

(75) Inventor: Wenfeng Liu, Qingdao (CN)

(73) Assignee: Qingdao Technological University, Qingdao (CN)

(21) Appl. No.: 13/585,273

(22) Filed: Aug. 14, 2012

Related U.S. Application Data
(63) Continuation of application No. PCT/CN2011/001787, filed on Nov. 25, 2011.

(30) Foreign Application Priority Data
May 20, 2011 (CN) 201110131954.2

(51) Int. Cl. G06F 17/50

(52) U.S. Cl. 703/1

(57) ABSTRACT

A method for determining a seismic design for a structure includes setting performance objectives; inputting the performance objectives into a single degree of freedom system to carry out a simulation test; continuously adjusting the size of seismic waves applied to the system to determine a relationship between performance demand and the period of the structure under different performance objectives; obtaining a seismic demand spectrum curve between a seismic influence coefficient or a spectral accelation and displacement performance objective in the single degree of freedom system; analyzing the relationship between the base shear force and the displacement of the engineering structure; converting the relationship into the relationship between the capacity and the displacement in the single degree of freedom system; obtaining a capacity spectrum curve; comparing the capacity spectrum curve with the performance demand spectrum curve; and assessing the seismic capacity of the structure under different performance objectives.

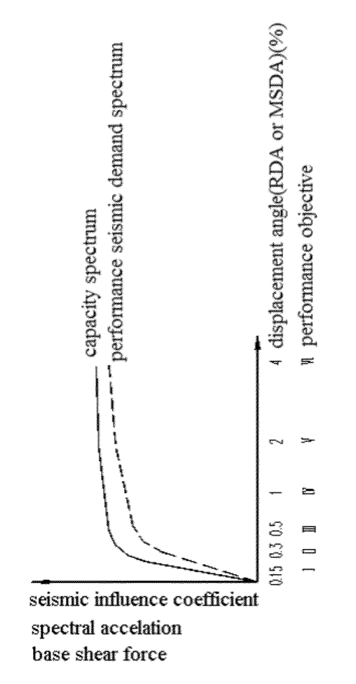

### CROSS-REFERENCE TO RELATED APPLICATIONS

The present application is a by-pass continuation application of PCT International Application No. PCT/CN2011/001787, filed in China on Nov. 25, 2011, and which claims the priority of CN 201110131954.2, which was filed in China on May 20, 2011. The present application incorporates by reference the entire contents of PCT International Application No. PCT/CN2011/001787 and CN 201110131954.2.

### FIELD OF INVENTION

The present invention relates to the engineering structure seismic design in the field of civil engineering, in particular, to a performance-based anti-seismic design approach.

### BACKGROUND OF INVENTION

Seismic design is the primary means to ensure the structural safety during the earthquake. All national engineering seismic designs are based on their anti-seismic design code.

Clause 5.2.1 and 5.2.2 in China's “Code for Seismic Design of Buildings” (GB50011-2010) have defined the seismic effect calculations under the action of ordinary earthquakes. Clause 5.5.2 and 5.5.3 have respectively defined the scope and method of the elasto-plastic deformation calculation under the action of rare earthquakes. However, these methods all calculate the seismic effect and deformation based on the set seismic intensities.

America's FEMA273 estimates the structural displacement by a multi-factor method. But it's also based on the set ground motion parameters. Both America's ATC40 and Japan's seismic code have adopted the capacity spectrum method which is also based on the set ground motion parameters to obtain performance points.

China's earthquake assessment techniques, such as No. CN101881089A patent made public on Nov. 10, 2010, discloses a steel tube concrete structure seismic performance evaluation method and its applications. It provides a finite element model for the space fiber beam in the steel tube concrete structure. Then it uses a software to calculate the finite element model and obtain the maximum inter-storey displacement angle (ISDA) of that structure. The seismic performance of the building steel is assessed by comparing the obtained angle with the ISDA limits set by relevant code. The seismic design of building will be made according to the seismic performance assessment results. But the engineering structure seismic design method is based on the set seismic intensities or ground motion parameters and still lacks of performance-objective-based seismic design approaches.

### SUMMARY OF THE INVENTION

The technology of this invention is able to overcome these shortcomings and provides a multi-objective performance-based structural engineering seismic design. It can be used to evaluate the seismic capacity of the structure under different performance objectives.

To achieve the above objectives, the present invention has adopted the following technical solutions.

(1) Setting performance objectives to be achieved by the engineering structures;

(2) Inputting different performance objectives into a single degree of freedom elastoplastic structural system to carry out the simulation test, such as dynamic time-history analysis or pseudo-earthquake shaking table test;

(3) Continuously adjusting the size of seismic waves to determine the function relations between the performance seismic demand (the seismic influence coefficient or the spectral acceleration) and the natural period of the structure under different performance objectives. According to the natural period of the structure, obtaining the seismic demand spectrum curve between the seismic influence coefficient or the spectral accelation and displacement performance objective in the single degree of freedom system or in the whole structure system. The spectral acceleration is the acceleration response of the structure. It can be measured by a simulation test or numerical calculation. The seismic influence coefficient is equal to the spectral acceleration divided by the gravitational constant g (gravity acceleration=9.8). Conversing/reversing the displacement angle; and adjusting torsion effect, gravity second-order effect, vertical irregularity, plane irregularity and detail requirement.

When a simulation test or numerical calculation is done, the response (the displacement) can be obtained. The displacement angle is equal to the response (the displacement) divided by the height of the building. Also, in another model expression, the story drift (the displacement) can be obtained. The displacement angle is equal to the story drift (the displacement) divided by the height of story. The torsion effect, the gravity second-order effect, and the detail requirement are factors that should be considered. There are many methods of obtaining these factors known to those of ordinary skill in the art.

(4) Analyzing the relationship between the base shear force and the displacement of the engineering structure;

(5) Conversing the relationship between the base shear force and the displacement into the function relations between the capacity and the displacement in the single degree of freedom system; and obtaining capacity spectrum curve in the single degree of freedom system;

(6) Comparing the capacity spectrum curve with the performance seismic demand spectrum curve in the single degree of freedom system or the whole structure system according to the structure periods; assessing the seismic capacity of the structure under different performance objectives.

The performance objectives can be expressed by the roof displacement angle (RDA) or the maximum story drift angle (MSDA). Carry out a simulation test by inputting different performance objectives into a single degree of freedom elastoplastic structural system and continuously adjusting the size of seismic waves. Obtain the function relations between the performance seismic demand(the seismic influence coefficient or the spectral accelation) and the structure period under different performance objectives. Determine the function relations between the performance seismic demand(the seismic influence coefficient or the spectral accelation) and the displacement angle. Chart the performance seismic demand spectrum curve in the single degree of freedom system or converse this curve in the whole structure system. Analyze the relationship between the base shear force and the displacement of the engineering structure. Converse the relationship between the base shear force and the displacement into the function relations between the capacity and the displacement in the single degree of freedom system and obtain the capacity spectrum curve in the single degree of freedom system. Comparing the capacity spectrum curve with the performance seismic demand spectrum curve in the single degree of freedom system or the whole structure system according to the structure periods; assessing the seismic capacity of the structure under different performance objectives.

The analysis methods include the static push-over method and the incremental dynamic method. The engineering structures include the frame structure, the shear wall structure, the frame-shear wall structure, the frame-supported shear wall structure , the tube-in-tube structure, and the frame-core tube structure. The engineering structures also include the simply supported plate girder bridge, the cantilever bridge, the continuous girder bridge, the T-shaped rigid frame bridge, the hanging bridge, the cable-stayed bridge, the suspension bridge, and the combined system bridge. The engineering structures also include the TV tower, the oil tank, the tower frame, the warehouse, the water tower, the water pool, the chimney, the tunnel and the dam.

The invention is based on a performance objective seismic design approach. This approach assesses the seismic performance of engineering structures and designs anti-seismic measures according to the assessment results.

### DRAWING DESCRIPTION

The drawing shows the comparison diagram of the capacity spectrum curve and the performance seismic demand spectrum curve under different performance objectives.

### IMPLEMENTATION

Design Method of this Invention Includes the Following Steps:

(1) Setting performance objectives to be achieved by the engineering structures;

(2) Inputting different performance objectives into a single degree of freedom elastoplastic structural system to carry out the simulation test, such as dynamic time-history analysis or pseudo-earthquake shaking table test;

(3) Continuously adjusting the size of seismic waves to determine the function relations between the performance seismic demand (the seismic influence coefficient or the spectral acceleration) and the structure period under different performance objectives. According to the structure period, obtaining the seismic demand spectrum curve between the seismic influence coefficient or the spectral accelation and displacement performance objective in the single degree of freedom system or in the whole structure system. Conversing/reversing displacement angle; and adjusting torsion effect, gravity second-order effect, vertical irregularity, plane irregularity and detail requirement;

(4) Analyzing the relationship between the base shear force and the displacement of the engineering structure;

(5) Conversing the relationship between the base shear force and the displacement into the function relations between the capacity and the displacement in the single degree of freedom system; and obtaining capacity spectrum curve in the single degree of freedom system;

(6) Comparing the capacity spectrum curve with the performance seismic demand spectrum curve in the single degree of freedom system or the whole structure system according to the structure periods; assessing the seismic capacity of the structure under different performance objectives.

1. Determine Performance Objectives to be Achieved by the Engineering Structures

The method determines key parameters for the performance objectives in consideration of the structural damages and with reference to Chinese, American, European and Japanese building codes. It further determines the quantitative displacement parameters according to both Chinese and foreign experimental data of different structures. For example, the RDA of the reinforcement frame structure can be set according to Table 1.If the MSDA is used, then it can be changed into the RDA. The MSDA and RDA can be obtained by PUSHOVER or IDA. If MSDA is determined, then the RDA can be obtained, because the RDA includes the MSDA for every story.

The performance levels in Table I are one type of performance objectives. The performance levels can be arbitrarily set by the user, such that the seismic capacity of the structure is more than the earthquake function according to the performance objectives, not the performance levels.

TABLE 1
Displacement Performance Objectives

| Performance Level | I | II | III | IV | V | VI |
|---|---|---|---|---|---|---|
| RDA (%) | 0.15 | 0.3 | 0.5 | 1 | 2 | 4 |

2. Determine the Functional Relationships Between the Performance Seismic Demand (the Seismic Influence Coefficient or the Spectral Accelation) and the Structure Period Under Different Performance Objectives

Input different performance objectives into a single degree of freedom elastoplastic structural system. Continuously adjust the size of seismic waves to determine the function relations between the performance seismic demand (the seismic influence coefficient or the spectral accelation) and the structure period under different performance objectives in the single degree of freedom system. Or converse this curve in the whole structure system. Converse/reverse displacement angle and adjust torsion effect, P-A effect, vertical irregularity, plane irregularity and detail requirement.

The seismic response can be calculated by a single degree of freedom elastoplastic dynamic differential equation inputting ground motions. Thus, the initial seismic response can be the performance objective, and then the ground motions can be adjusted. If the seismic response to the input ground motion is equal to the performance objective, it is OK. The earthquake function (the input ground motion) is then obtained according to the performance objectives. This is a dynamic time-history analysis, and the pseudo-earthquake shaking table test is the same.

3. Determine the Function Relations Between the Capacity and the Displacement in the Single Degree of Freedom System or in the Whole Structure System.

(1) Conduct the static push-over analysis and apply a certain distribution of horizontal loads on the structure. Increase the horizontal loads monotonically. Or conduct the incremental dynamic analysis and progressively increase the level of ground motion input. While the component yields gradually, obtain the elastic-plastic plastic response of the structure under the increasing load. Finally obtain the capacity spectrum curve of the whole structure. Thus, when a force is applied on a structure, the MSDA and the RDA can be obtained from the response to the structure. The force changes larger and larger step by step, so we can obtain many MSDA and RDA values from force 0 to the final collapsing force.

(2) Calculate the equivalent modal participation factor and the equivalent modal mass

$${γ}_{j} = \frac{{\sum }_{i = 1}^{N} {φ}_{i , j} {G}_{i}}{{\sum }_{i = 1}^{N} {φ}_{i , j}^{2} {G}_{i}} \qquad ( 1 )$$

where,

γⱼ—j order modal participation factor;

φ_{i,j}—mass point i at j order mode;

Gᵢ—representing value of the on behalf of the gravity load of mass point i.

Calculate the equivalent mode:

$${φ}_{i , eq} = \sqrt{{\sum }_{j = 1}^{m} {( {φ}_{i , j} {γ}_{j} )}^{2}} \qquad ( 2 )$$

Where,

φ_{i,eq}—equivalent vibration mode of mass point i with multiple degrees of freedom.

m—number of modes, m=1 shall be used for the approximate calculation.

Calculate the equivalent modal participation factor (┌_{eq}) and the equivalent modal mass (M_{eq}):

$$\begin{matrix}{Γ}_{eq} = \frac{{\sum }_{i = 1}^{N} {m}_{i} {φ}_{i , eq}}{{\sum }_{i = 1}^{N} {m}_{i} {φ}_{i , eq}^{2}} & ( 3 ) \\ {M}_{eq} = \frac{{( {\sum }_{i = 1}^{N} {m}_{i} {φ}_{i , eq} )}^{2}}{{\sum }_{i = 1}^{N} {m}_{i} {φ}_{i , eq}^{2}} & ( 4 )\end{matrix}$$

(3) Determine the function relations between the capacity and the displacement in the single degree of freedom system

$$\begin{matrix}{S}_{d} = {u}_{eq} = \frac{1}{{Γ}_{eq}} u & ( 5 ) \\ {V}_{eq} = \frac{1}{{Γ}_{eq}^{2}} V & ( 6 ) \\ {S}_{a} = \frac{{V}_{eq}}{{M}_{eq}} & ( 7 ) \\ α = \frac{{S}_{a}}{g} & ( 8 )\end{matrix}$$

Where,

S_{d}, u_{eq}—the displacement in the single degree of freedom system;

u—RDA obtained by PUSHOVER or IDA;

V—Force that leads to u;

Sₐ, α—the equivalent structure capacity (the seismic influence coefficient or the spectral accelation) in the single degree of freedom system. Converse the relationship between the base shear force and the displacement into the function relations between the capacity and the displacement in the single degree of freedom system.

4 Compare the capacity spectrum curve with the performance seismic demand spectrum curve under different performance objectives

(1) Determine the Performance Seismic Demand Spectrum

From the function relations between the performance seismic demand(the seismic influence coefficient or the spectral accelation) and the structure period under different performance objectives in the single degree of freedom system, determine the function relations between the performance seismic demand(the seismic influence coefficient or the spectral accelation) and the displacement angle and obtain the performance seismic demand spectrum curve in the single degree of freedom system. Or converse this curve in the whole structure system. Chart the curve on the coordination in the drawing.

(2) Determine the Capacity Spectrum

From the function relations between the capacity and the displacement in the single degree of freedom system or the whole structure system. Obtain the capacity spectrum curve. Chart the curve on the coordination in the drawing.

(3) Compare the Capacity Spectrum Curve with the Performance Seismic Demand Spectrum Curve Under Different Performance Objectives

Compare the capacity spectrum curve with the performance seismic demand spectrum curve in the single degree of freedom system or the whole structure system. Evaluate seismic capacity of the structure under different performance objectives. See the drawing.

1. A method for determining a multi-objective performance-based seismic design for an engineering structure, the method comprising:
setting performance objectives to be achieved by the engineering structures;
inputting the performance objectives into a single degree of freedom elastoplastic structural system to carry out a simulation test;
continuously adjusting the size of seismic waves applied to the system to determine a functional relationship between a performance seismic demand and the natural period of the engineering structure under different performance objectives;
obtaining a seismic demand spectrum curve between a seismic influence coefficient or a spectral accelation and displacement performance objective in the single degree of freedom system or in the whole structure system;
analyzing the relationship between the base shear force and the displacement of the engineering structure;
converting the relationship between the base shear force and the displacement into the functional relationship between the capacity and the displacement in the single degree of freedom system;
obtaining a capacity spectrum curve in the single degree of freedom system;
comparing the capacity spectrum curve with the performance seismic demand spectrum curve in the single degree of freedom system or the whole structure system according to the structure periods; and
assessing the seismic capacity of the structure under different performance objectives.

2. The engineering structure multi-objective performance-based seismic design specified in claim 1 is further characterized by its static push-over analysis method.

3. The engineering structure multi-objective performance-based seismic design specified in claim 1 is further characterized by its incremental dynamic analysis method.

4. The engineering structure multi-objective performance-based seismic design specified in claim 2 is further characterized by its incremental dynamic analysis method.

5. The engineering structure multi-objective performance-based seismic design specified in claim 4 is characterized in that the engineering structures include the frame structure, the shear wall structure, the frame-shear wall structure, the frame-supported shear wall structure , the tube-in-tube structure, and the frame-core tube structure.

6. The engineering structure multi-objective performance-based seismic design specified in claim 4 is further characterized in that the engineering structures include the simply supported plate girder bridge, the cantilever bridge, the continuous girder bridge, the T-shaped rigid frame bridge, the hanging bridge, the cable-stayed bridge, the suspension bridge, and the combined system bridge.

7. The engineering structure multi-objective performance-based seismic design specified in claim 4 is further characterized in that the engineering structures include the TV tower, the oil tank, the tower frame, the warehouse, the water tower, the water pool, the chimney, the tunnel and the dam.

8. The engineering structure multi-objective performance-based seismic design specified in claim 1, wherein the performance seismic demand is the seismic influence coefficient or the spectral acceleration.

9. The engineering structure multi-objective performance-based seismic design specified in claim 1, wherein the simulation test is a dynamic time-history analysis.

10. The engineering structure multi-objective performance-based seismic design specified in claim 1, wherein the simulation test is a pseudo-earthquake shaking table test.

11. The engineering structure multi-objective performance-based seismic design specified in claim 1, further comprising conversing/reversing displacement angle; and adjusting torsion effect, the gravity second-order effect, vertical irregularity, plane irregularity and detail requirements.
